(19) United States
(12) Patent Application Publication
(10) Pub. No.: US 2007/0248307 A1
(43) Pub. Date: Oct. 25, 2007

(54) TRANSPARENT LIGHT EMITTING MEMBERS AND METHOD OF MANUFACTURE

(76) Inventors: David J. Page, Painesville, OH (US); Brian M. Spahnie, Brunswick, OH (US)

Correspondence Address: RENNER OTTO BOISSELLE & SKLAR, LLP, 1621 EUCLID AVENUE, NINETEENTH FLOOR, CLEVELAND, OH, 44115, US

(21) Appl. No.: 11/768,230

(22) Filed: Jun. 26, 2007

Related U.S. Application Data
(63) Continuation-in-part of application No. 10/900,000, filed on Jul. 27, 2004.
(63) Continuation-in-part of application No. 11/126,655, filed on May 11, 2005.
(62) Division of application No. 10/264,576, filed on Oct. 4, 2002, now Pat. No. 6,910,783.

(51) Int. Cl. G02B 6/02; C03B 37/075

(52) U.S. Cl. 385/123; 65/392

(57) ABSTRACT

Light emitting members or illuminators in the form of a light guide which may comprise one or more flat optical fibers having a pattern of U shaped notches or grooves in at least one side to cause conducted light to be emitted therefrom. A laser may be used to cut any desired pattern of notches or grooves in the light guide.

### CROSS-REFERENCE TO RELATED APPLICATIONS

This application is a continuation-in-part of U.S. patent application Ser. No. 10/900,000, filed Jul. 27, 2004 and a continuation-in-part of U.S. patent application Ser. No. 11/126,655, filed May 11, 2005, which is a division of U.S. patent application Ser. No. 10/264,576, filed Oct. 4, 2002, now U.S. Pat. No. 6,910,783, dated Jun. 28, 2005.

### FIELD OF THE INVENTION

This invention relates to transparent light emitting members that have specially shaped notches or grooves in one or more surfaces to create a selected light output distribution from such members and their method of manufacture.

### BACKGROUND OF THE INVENTION

It is well known that light transparent members including for example rods, panels, films, sheets and plates, can be made into light emitting members or illuminators by notching the members in a certain pattern. However, such notches are typically relatively sharp grooves, which do not scatter light very finely. Also the sharp grooves make the light emitting members more susceptible to breakage during installation or when placed under tension. The light emitting members may be used, for example, as a back light and/or front light for transparent or translucent devices such as LCDs, dials, gauges, pictures, point of sale advertising, decorative devices, and so on. Also such light emitting members may have special usages in optical scanning and array devices and the like.

### SUMMARY OF THE INVENTION

In accordance with one aspect of the invention, the light emitting members have rounded shallow notches or grooves in one or more surfaces that scatter the light emitted from the members.

In accordance with another aspect of the invention, the rounded shallow notches or grooves reduce the risk of breakage of the light emitting members during installation or when the members are placed under tension.

In accordance with another aspect of the invention, the notches or grooves are generally U or C shaped.

In accordance with another aspect of the invention, the light emitting members with rounded shallow notches or grooves are relatively inexpensive and easy to manufacture.

In accordance with another aspect of the invention, the light emitting members with rounded shallow notches or grooves allow for easy low volume manufacturability of the members with any desired amount of smoothness or roughness on the faces of the notches or grooves.

In accordance with still another aspect of the invention, the light emitting members may have special arcuate shapes for use in special lighting applications.

In accordance with still another aspect of the invention, the light emitting members may comprise one or more flat optical fibers having a pattern of shallow U or C shaped notches or grooves along at least a portion of the length of the fibers to cause conducted light to be emitted from the fibers.

In accordance with another aspect of the invention, a laser may be used to cut a pattern of U or C shaped notches or grooves in at least one side of the light emitting members.

In accordance with another aspect of the invention, the laser may be coupled to an X-Y table on which the light emitting members are supported to cut a prescribed pattern of the notches or grooves in the light emitting members.

In accordance with another aspect of the invention, the laser may be intermittently pulsed, and the laser and light emitting members may be moved relative to one another in an X and/or Y direction between pulses to cut a plurality of spaced apart notches or grooves in the light emitting members.

In accordance with another aspect of the invention, the laser may be controlled to vary the depth, width, spacing, relative position, diameter, and/or surface finish of the notches or grooves in the pattern to control the amount of light extracted from the light emitting members by the notches or grooves.

In accordance with another aspect of the invention, the laser may be moved at a substantially constant speed relative to the light emitting members during continuous pulsing of the laser to cut relatively uniform single depth notches or grooves in the light emitting members.

In accordance with another aspect of the invention, the laser may be moved at a variable speed relative to the light emitting members during continuous pulsing of the laser to cut relatively long variable depth grooves in the light emitting members.

In accordance with another aspect of the invention, the laser may be moved at a substantially constant speed relative to the light emitting members while the laser is intermittently pulsed to cut a plurality of grooves having substantially the same depth in the light emitting members.

In accordance with another aspect of the invention, the laser may be de-focused during laser pulsing to provide the notches or grooves with a roughened or bubbled surface finish.

In accordance with another aspect of the invention, the diameter of the laser beam may be varied during laser pulsing to vary the width of the notches or grooves along their length to cause more or less transmitted light to be extracted from the light emitting members.

In accordance with another aspect of the invention, the laser power level may be varied during laser pulsing to vary the width and depth of the notches or grooves.

These and other aspects of the present invention will become apparent as the following description proceeds.

To the accomplishment of the foregoing and related ends, the invention, then, comprises the features hereinafter fully described and particularly pointed out in the claims, the following description and the annexed drawings setting forth in detail certain illustrative embodiments of the invention, these being indicative, however, of but several of the various ways in which the principles of the invention may be employed.

### BRIEF DESCRIPTION OF THE DRAWINGS

In the annexed drawings:

FIG. 1 is a schematic side elevation view of a rod-like transparent light emitting member of the present invention having a pattern of rounded shallow notches or grooves in a surface of the member for causing light entering the member to be reflected or refracted (i.e., emitted) from the member.

FIG. 2 is an enlarged fragmentary section through the light emitting member and one of the notches or grooves of FIG. 1.

FIG. 3 is a schematic side elevation view of a rod-like transparent light emitting member of the invention shown lighted from both ends rather than just one end as shown in FIG. 1.

FIGS. 4a and 4b are schematic fragmentary side elevation views of an end portion of a light emitting member of the present invention showing alternative ways of optically coupling a light source to an edge of the member.

FIGS. 5-9 are schematic end elevation views of rod-like light emitting members of the type shown in FIGS. 1-3 having different cross-sectional shapes, FIG. 5 showing a cylindrical cross-sectional shape, FIG. 6 showing an elliptical cross-sectional shape, FIG. 7 showing a semi-cylindrical cross-sectional shape, FIG. 8 showing a rectangular cross-sectional shape, and FIG. 9 showing a triangular cross-sectional shape.

FIG. 10 is a schematic end elevation view of a rod-like light emitting member of the present invention having a rectangular cross-sectional shape similar to FIG. 8 but with three sides having rounded shallow notches or grooves instead of just one as shown in FIG. 8 to produce a brighter light output.

FIGS. 11 and 13 are schematic side elevation views of other rod-like light emitting members of the present invention having different notching patterns to produce a desired light output distribution from such members.

FIGS. 12 and 14 are schematic end elevation views of the light emitting members of FIGS. 11 and 12, respectively, as seen from the right ends thereof.

FIG. 15 is a schematic side elevation view of another rod-like light emitting member of the present invention having a rounded shallow notch or groove extending longitudinally along the member.

FIG. 16 is a schematic transverse section through the light emitting member and rounded groove of FIG. 15, taken along the plane of the line 16-16 thereof.

FIG. 17 is an enlarged schematic perspective view of a length of flat optical fiber that may be used to make the light emitting members/illuminators of the present invention.

FIG. 18 is an enlarged schematic perspective view showing a surface mount light source optically coupled to an end of a flat optical fiber of a light emitting member.

FIG. 19 is an enlarged schematic perspective view showing a plurality of surface mount light sources optically coupled to an end of one flat optical fiber of a light emitting member.

FIG. 20 is an enlarged schematic perspective view showing surface mount light sources optically coupled and mechanically attached to the ends of a plurality of spaced apart flat optical fibers of the light emitting member.

FIG. 21 is an enlarged schematic perspective view showing a laser being used to cut different patterns of U or C shaped notches or grooves in one side of a light emitting member.

### DETAILED DESCRIPTION OF THE INVENTION

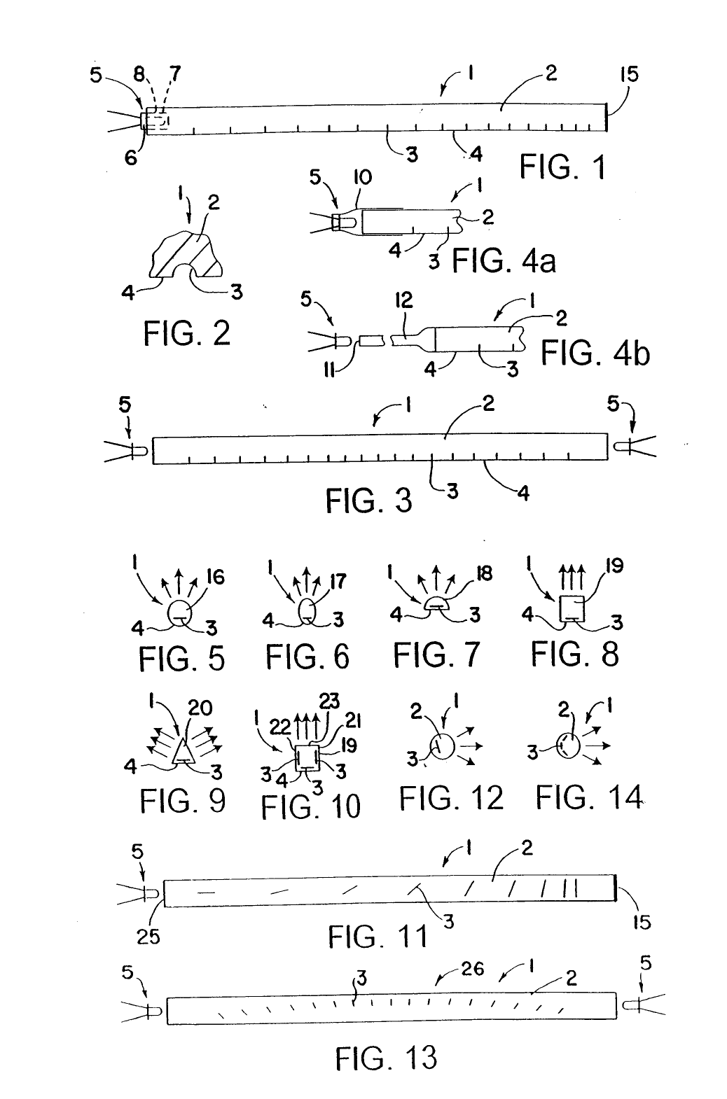

Referring now in detail to the drawings, and initially to FIG. 1, there is shown one transparent light emitting member 1 of the present invention in the shape of an elongated rod 2 having a pattern of notches or grooves 3 in a surface 4 of the member for causing light that is transmitted through the member by internal reflection to be reflected or refracted out of the member as well known in the art. However, the notches or grooves 3 of the present invention, rather than being relatively sharp grooves as is conventional practice, are rounded shallow notches or grooves each having a generally U or C cross-sectional shape as schematically shown in FIG. 2. These rounded generally U or C shaped notches or grooves 3 (hereafter collectively referred to as U shaped notches or grooves) may have a minimum depth and width of radius of no more than a few thousandths of an inch, depending on the length and thickness of the light emitting member, and have the advantage that they will scatter the light more finely than sharp grooves and will reduce the risk of breakage of the members during installation or when the members are placed under tension. Also the surfaces of the notches or grooves may be smooth or textured or roughened as desired to extract less or more light out through the notches or grooves.

Such light emitting members may be molded or cast or machined or cut out of any suitable transparent, clear or colored (including scintillating or fluorescent) material including glass or plastic such as acrylic, polycarbonate, styrene, or urethane or the like. The notches or grooves 3 may be painted or covered with a reflective color. Also, different notches may be coated with different colors for decorative or visibility purposes when the light emitting member is lighted by one or more white light sources.

Such light emitting members may be lighted from one or both end edges using any suitable light source 5. The rod-like light emitting member 2 of FIG. 1 is shown lighted from one end by a narrow angle light emitting diode (LED) 6 inserted in a slot, cavity or opening 7 machined, molded, cast or otherwise formed in the light emitting member. Light source 5 may be held in place within the opening 7, for example, by an interference fit or by embedding, potting or bonding the light source in place using a suitable embedding, potting or bonding material 8. Bonding can also be accomplished using a variety of methods that do not incorporate extra material, for example, thermobonding, heat staking, ultrasonic or plastic welding or the like. Other methods of bonding include insert molding and casting around the light source.

The light source 5 may also be held adjacent an edge of light emitting member 1 using for example a few drops of adhesive, or by heat shrinking a heat-shrinkable tube 10 around both the light source 5 and an edge of the light emitting member 1 as schematically shown in FIG. 4a. Also a remote light source 5 may be optically coupled to the edge of the light emitting member by focusing the light source on the input surface 11 of a light guide 12 suitably connected to the light emitting member as schematically shown in FIG. 4b.

If LEDs are used as the light source, suitable holes 7 may be molded or cast in one or more edges of the light emitting member for receipt of the LEDs as schematically shown in FIG. 1.

Using LEDs as the light source has the benefit that LEDs produce very little heat, consume small amounts of electric power, have a relatively long life, are relatively inexpensive, are not damaged by vibration, and do not produce EMI. However, other types of light sources may also be used including, for example, an arc lamp, an incandescent bulb, a lens end bulb, a line light, a halogen lamp, a neon bulb, a fluorescent tube, a fiber optic light pipe transmitting from a remote source, a laser or laser diode, or any other suitable light source.

The density and/or depth or size of the notches 3 may be varied along the surface of the light emitting member 1 in order to obtain a selected light output distribution from the member. For example, the amount of light traveling through the light emitting member will ordinarily be greater in areas closer to the light source than in areas further removed from the light source. The pattern of notches or grooves 3 may be used to adjust for the light variances within the light emitting member, for example, by placing the notches 3 closer together as the distance from the light source increases to provide a more uniform light output distribution from the light emitting member. Also, depending on the length and cross-sectional thickness of the light emitting member, the notches 3 may be made progressively deeper and/or wider with increased distance from the light source to provide a more uniform light output from the member.

When the light emitting member is lighted from one end only as shown in FIG. 1, placing the notches 3 progressively closer together and/or making the notches progressively deeper and/or wider as the distance from the lighted end edge increases will result in a more uniform light output distribution from the light emitting member. Further, the faces of the notches may be made progressively more textured or rougher with increased distance from the light source to provide a more uniform light output distribution from the member.

A reflective film or coating 15 may be provided on the non-lighted end edge of the light emitting member (if lighted from only one end edge as schematically shown in FIG. 1) as by applying a reflective film to such non-lighted end edge or coating such non-lighted end edge with white or silver reflective paint to minimize light loss from such non-lighted end edge.

The light emitting member 1 may also be lighted from both ends as schematically shown in FIG. 3 for increased light output. In that event, the notches or grooves 3 may be placed closer and closer together as the distance from both lighted end edges increases toward the middle where the concentration of the notches will be greatest to provide a more uniform light output distribution from the light emitting member.

FIG. 5 shows the rod-like light emitting member 1 of the invention as having a cylindrical cross-sectional shape 16. However, light emitting member 1 may have other cross-sectional shapes as well for varying the output ray angle distribution of the emitted light to suit a particular application. For example, changing the cross-sectional shape of the member 1 from the cylindrical cross-section 16 shown in FIG. 5 to an elliptical cross-section 17 as shown in FIG. 6 will narrow the view angle of the light produced, whereas changing the cross-sectional shape to a semi-cylindrical cross-section 18 as shown in FIG. 7 will widen the view angle.

If a non-angular light output is desired, a rectangular cross-sectional shape 19 as shown in FIG. 8 or a triangular cross-sectional shape 20 as shown in FIG. 9 may be used. Also, the light output distribution from a light emitting member 1 with a rectangular cross-sectional shape 19 can be made brighter by notching three of the four sides 4, 21, 22 and 23 instead of just one of the sides 4 as schematically shown in FIG. 10.

FIGS. 11 and 12 show a variation of the notching pattern along a rod-like light emitting member 1 in which the notches 3 closest to the lighted end 25 are made relatively parallel to the light emitting member to cause a relatively small percentage of the transmitted light to be emitted and the notches 3 further removed from the lighted end are made more and more perpendicular to the axis of the light emitting member as the distance from the lighted end increases to cause a greater percentage of the transmitted light to be emitted to produce a more uniform light output distribution from the light emitting member.

FIGS. 13 and 14 show another pattern of notches 3 extending along the length of a rod-like light emitting member 1 that is lighted from both ends. In this embodiment the notches 3 are located along an arc 26, with the notches closest to the top surface of the member adjacent the middle producing brighter light when viewed from the proper angle.

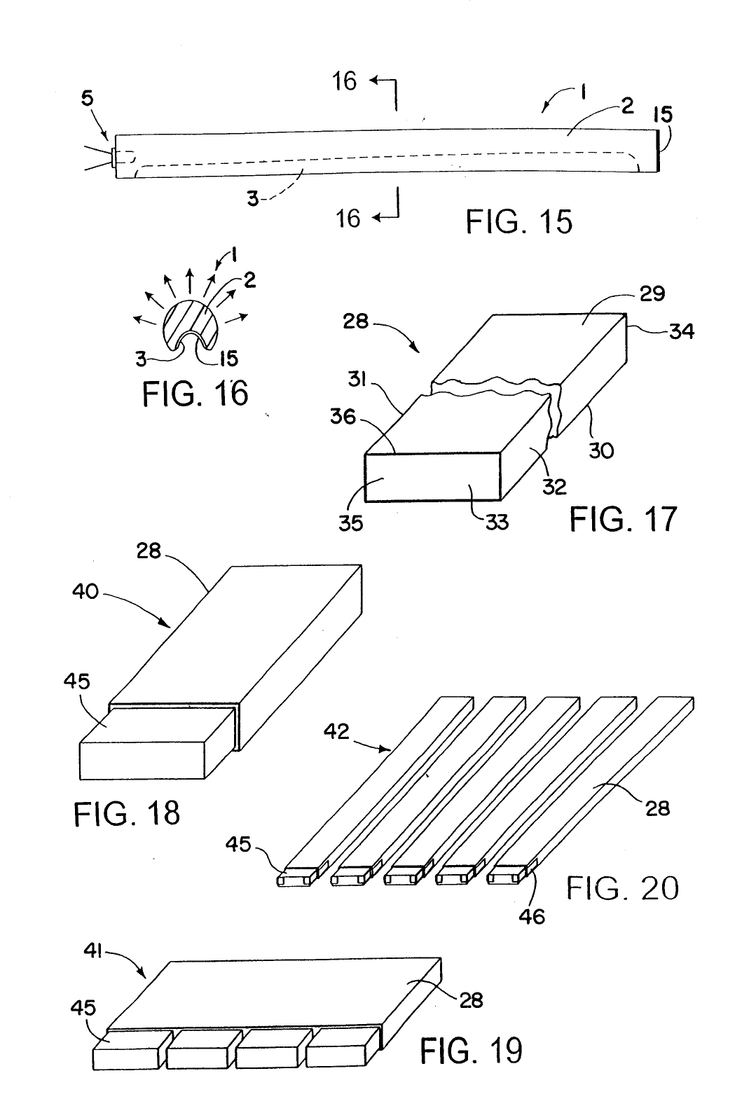

FIGS. 15 and 16 show another rod-like light emitting member 1 of the invention in which a rounded shallow notch or groove 3 extends along the length of the member for causing light to be emitted therefrom. The groove 3 may be coated with a suitable reflective material 15 such as reflective paint or tape as schematically shown in FIG. 16 to increase its effectiveness in reflecting light.

If the light emitting member 1 of FIGS. 15 and 16 is lighted from one end only as schematically shown in FIG. 15, the depth of the light emitting groove 3 may if desired progressively increase as the distance from the lighted end increases to produce a more uniform light output distribution. Also, the unlighted end edge of the light emitting member 1 may be coated with a suitable reflective material 15 such as reflective paint or tape.

If the light emitting member 1 of FIGS. 15 and 16 is lighted from both ends, the groove 3 may if desired be made shallower at the ends and progressively deeper from the ends toward the middle to produce a more uniform light output distribution from the member. Moreover, while the rod-like light emitting member 1 shown in FIGS. 15 and 16 has a generally cylindrical cross-section, the light emitting member may have other cross-sectional shapes including for example the semi-cylindrical, elliptical, square and triangular shapes previously discussed to obtain a desired light output distribution to suit a particular application.

The light emitting member may also comprise one or more optical fibers for increased efficiency in keeping the light in longer and allowing the light to be distributed/emitted where desired. Moreover, instead of using round optical fibers, the optical fibers may be flat. Using flat optical fibers has the advantage that more surface area of the optical fibers can be disrupted using known marring or braiding techniques for increased brightness for a given light emitting surface area.

Another advantage of using flat optical fibers instead of round optical fibers is that the ends of the flat optical fibers need not be bundled and secured together by a connector assembly to serve as an interface between the fiber ends and the light source as do round optical fibers. Flat optical fibers may be manufactured in different thicknesses and widths to make it easier and more efficient to couple one or more light sources including particularly surface mount light sources such as surface mount light emitting diodes to the flat optical fiber ends. Surface mount light emitting diodes are generally rectangular in cross-section, which makes it relatively easy to optically couple them to the ends of the optical fibers by making the flat optical fibers of substantially the same thickness and either the same or greater width than the light sources. If the flat optical fibers have a width substantially greater than that of the light sources, multiple light sources may be optically coupled to the end of each optical fiber to provide for increased brightness. Also because the ends of the flat optical fibers need not be bundled together by a connector assembly to serve as an interface between the optical fiber ends and the light source, the need for space to receive and store bundled round optical fiber ends is eliminated.

Still another advantage in making light emitting members out of flat optical fibers instead of round optical fibers is that a fewer number of wider flat optical fibers may be used to produce an equivalent light output. Flat optical fiber light emitters may be comprised of one or more flat optical fibers depending on the light output requirements of the light emitters. A unique quality of a single flat optical fiber is that it can be cut to a curved, rounded or angled configuration if desired.

Where multiple flat optical fibers are used, the flat optical fibers may be held together or mounted separately and may if desired have gaps therebetween for lighting different areas of a display including for example a liquid crystal display, graphic display or different rows of keys of a keyboard or the like as disclosed, for example, in U.S. patent application Ser. No. 10/900,000, the entire disclosure of which is incorporated herein by reference.

FIG. 17 shows one such flat optical fiber 28 which may be of any desired length having opposite flat sides 29 and 30 and opposite side edges 31 and 32 and ends 33 and 34. The flat optical fiber 28 has a light transmitting core portion 35 made of a suitable optically transparent material such as glass or plastic having the desired optical characteristics and flexibility. Surrounding the core portion 35 is an outer sheath or cladding 36 having an index of refraction that is different than that of the core material, whereby substantially total internal reflection is obtained at the core-cladding interface, as well known in the art.

The size, including thickness, width and length of the flat optical fibers as well as the number of flat optical fibers used to make a particular light emitting member in accordance with the present invention may be varied depending on the particular application, as may the size, type and number of light sources used to supply light to one or both ends of the flat optical fibers. For example, the flat optical fibers used to make a particular light emitting member may have a thickness of between 0.010 inch and 0.035 inch or even between 0.004 inch and 0.010 inch and a width of between 0.070 inch and 3 inches, with a ratio of thickness to width of less than 0.5. Also the flat optical fibers will typically have a length greater than 5 inches, with a ratio of thickness to length of less than 0.007. However, for certain applications such as cell phones, the flat optical fibers may have a shorter length, for example, 1 to 3 inches. Also, the flat optical fibers may be made sufficiently flexible for use in activating a switch.

FIGS. 18 and 19 show light emitting members 40 and 41 each comprised of a single flat optical fiber 28 of different widths, lengths and/or thicknesses, whereas FIG. 20 shows a light emitting member 42 comprised of multiple flat optical fibers 28 of different lengths, widths and/or thicknesses. In FIGS. 18 and 20 flat optical fibers 28 are shown as having a thickness and width substantially corresponding to the thickness and width of a suitable surface mount type light source 45 such as a surface mount light emitting diode (LED) for direct coupling of the light sources to an end of the optical fibers. The flat optical fibers 28 shown in FIG. 19 also have a thickness substantially corresponding to the thickness of a surface mount type light source 45, but have a width substantially greater than the width of the surface mount type light source to permit direct coupling of a plurality of such light sources to an end of each optical fiber if desired.

For example, the surface mount type LED 45 may have a rectangular cross-sectional shape with a thickness of approximately 0.030 inch and a width of approximately 0.200 inch, and the flat optical fibers 28 may have substantially the same thickness as the LEDs and either substantially the same width as the LEDs for optically coupling one LED to an end of each flat optical fiber as shown in FIGS. 18 and 20 or a substantially greater width for coupling one or more light sources to an end of each flat optical fiber as shown in FIG. 19. As used herein, the term light emitting diode or LED means and includes a standard surface mount type LED as well as a surface type mount polymer light emitting diode (PLED) or surface mount type organic light emitting diode (OLED).

One or more of the light sources 45 may be attached to an end of one or more flat optical fibers 28 by a mechanical clip or other type fastener 46 as shown in FIG. 20. Alternatively the light sources may simply be positioned and supported adjacent an end of the flat optical fibers.

To cause conducted light entering one or both ends of one or more of any of the light emitting members of the present invention to be emitted from one or more sides thereof, the rounded shallow U shaped notches or grooves similar to those shown in FIGS. 2 and 16 may be provided at one or more areas along their length in the manner previously described.

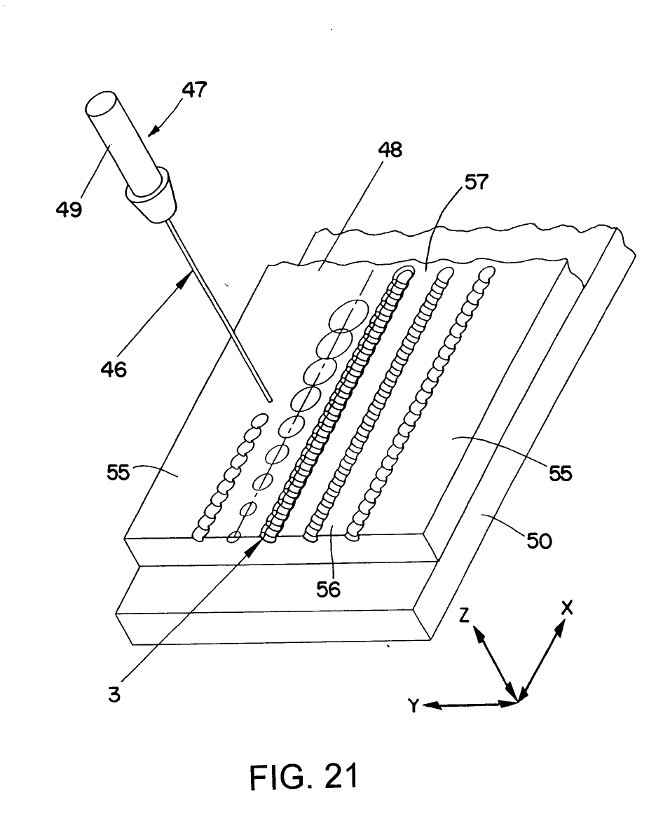

Alternatively, a laser may be used to cut a pattern of generally U shaped notches or grooves in one or more sides of the light emitting members. FIG. 21 schematically shows the beam 46 of a laser 47 being used to cut different patterns of such U shaped notches or grooves 3 in one side of a light emitting member (e.g., light guide) 48.

Laser 47 includes a mirrored laser head 49 that cuts the notches or grooves in a prescribed pattern in the light guide, and may be coupled to an X-Y table 50 on which the light guide is supported during the cutting operation.

Laser 47 may include one or more of the following control factors to cut the notches or grooves in a prescribed pattern in the light guide: variable focus, variable power level, variable beam diameter, variable pulse duration, variable direction of laser pulsing relative to direction of transmitted light in the light guide; and variable speed cutting laser head or table. For example, one or more of the control factors may be varied in a predetermined manner to vary the cut, size, finish and/or placement of the notches or grooves 3 in the light guide. Also the laser 47 may be controlled to vary the depth, width, spacing, relative position, diameter and/or surface finish of the notches or grooves in the pattern to control the amount of light extracted from the light guide 47 by the notches or grooves. Moreover, the laser 47 may be controlled so that the notches or grooves in the pattern closest to the lighted end are made relatively parallel to the light emitting member to cause a relatively small percentage of the transmitted light to be emitted and the notches or grooves further removed from the lighted end may be made to run at an angle to the direction of the transmitted light and finally perpendicular to the direction of the transmitted light as the distance from the lighted end increases as shown in FIG. 11 to cause a greater percentage of the transmitted light to be emitted to produce a more uniform light output distribution from the light emitting member.

Laser 47 may also be intermittently pulsed and the laser and light guide may be moved relative to one another in the X and/or Y direction between pulses to cut a plurality of spaced apart notches or grooves 3 in the light guide as shown in FIG. 21. Also the laser may be moved at a substantially constant speed relative to the light guide during continuous pulsing of the laser to cut relatively uniform single depth notches or grooves in the light guide or moved at a variable speed relative to the light guide during continuous pulsing of the laser to cut relatively long variable depth grooves in the light guide. Further, when the laser is moved at a substantially constant speed relative to the light guide, the laser may be intermittently pulsed to cut a plurality of notches or grooves having substantially the same depth in the light guide. Also, the pulses may be uniformly spaced apart so that the notches or grooves are uniformly spaced apart so the transmitted light is extracted in a consistent manner or the spacing between the pulses may be varied to vary the spacing between the notches or grooves to cause more or less of the transmitted light to be extracted from the light guide. Moreover, the laser may be de-focused during laser pulsing to provide the notches or grooves with a roughened or bubbled surface finish. In addition, the laser beam diameter and/or power level to the laser may be varied during laser pulsing to vary the width and/or depth of the notches or grooves along their length to cause more or less transmitted light to be extracted from the light guide.

A portion of the surface of the light guide may also be coated with a masking material 55, and a pattern of shallow U shaped notches or grooves 3 may be laser cut in the unmasked areas 56 of the surface as shown in FIG. 21. Moreover, at least some of the surface of the unmasked area 56 of the light guide may be coated with a material 57 to enhance laser cutting of the surface as further shown in FIG. 21.

Where the light guide is an optical fiber including a light conducting core and a cladding surrounding the core, the notches or grooves may extend through the cladding and at least part way through the core. Also, regardless of the shape of the light emitting members, the notches or grooves may be provided on more than one side of the members as desired. Moreover, any of the light emitting members of the present invention may be curved along their length to suit a particular application.

Although the invention has been shown and described with respect to certain embodiments, it is obvious that equivalent alterations and modifications will occur to others skilled in the art upon the reading and understanding of the specification. In particular, with regard to the various functions performed by the above described components, the terms (including any reference to a “means”) used to describe such components are intended to correspond, unless otherwise indicated, to any component which performs a specified function of the described component (e.g., that is functionally equivalent), even though not structurally equivalent to the disclosed component which performs the function in the herein illustrated exemplary embodiments of the invention. Also, all of the disclosed functions may be computerized and automated as desired. In addition, while a particular feature of the invention may have been disclosed with respect to only one of several embodiments, such feature may be combined with one or more other features of the other embodiments as may be desired and advantageous for any given or particular application.

What is claimed is:

1. A method of making an illuminator out of a light guide having at least one light receiving edge for receiving light from a light source for transmission through the light guide by internal reflection comprising using a laser to cut a pattern of U shaped notches or grooves in at least one side of the light guide to cause at least some of the transmitted light to be extracted from the light guide.

2. The method of claim 1 wherein the laser is intermittently pulsed, and the laser and light guide are moved relative to one another in an X and/or Y direction between pulses to cut a plurality of spaced apart notches or grooves in the light guide.

3. The method of claim 1 wherein the laser includes a mirrored laser head that cuts the notches or grooves in a prescribed pattern in the light guide.

4. The method of claim 1 wherein the laser is coupled to an X-Y table on which the light guide is supported to cut a prescribed pattern of the notches or grooves in the light guide.

5. The method of claim 1 wherein the laser includes one or more of the following control factors to cut the notches or grooves in a prescribed pattern in the light guide: variable focus, variable power level, variable beam diameter, variable pulse duration, variable direction of laser pulsing relative to direction of transmitted light in the light guide, and variable speed cutting laser head or table.

6. The method of claim 5 wherein one or more of the control factors are varied in a predetermined manner to vary the cut, size, finish and/or placement of the notches or grooves in the light guide.

7. The method of claim 1 wherein the laser is controlled to vary the depth, width, spacing, relative position, diameter and/or surface finish of the notches or grooves in the pattern to control the amount of light extracted from the light guide by the notches or grooves.

8. The method of claim 1 wherein the laser is controlled to vary the depth of the notches or grooves in the pattern to cause more or less light to be extracted by the notches or grooves.

9. The method of claim 1 wherein the laser is controlled so that the notches or grooves in the pattern run parallel to the direction of the transmitted light in the light guide.

10. The method of claim 1 wherein the laser is controlled so that the notches or grooves in the pattern run perpendicular to the direction of the transmitted light in the light guide.

11. The method of claim 1 wherein the laser is controlled so that the notches or grooves in the pattern run at an angle to the direction of the transmitted light in the light guide.

12. The method of claim 1 wherein the laser is moved at a substantially constant speed relative to the light guide during continuous pulsing of the laser to cut relatively uniform single depth notches or grooves in the light guide.

13. The method of claim 1 wherein the laser is moved at a variable speed relative to the light guide during continuous pulsing of the laser to cut relatively long variable depth grooves in the light guide.

14. The method of claim 1 wherein the laser is moved at a substantially constant speed relative to the light guide while the laser is intermittently pulsed to cut a plurality of notches or grooves having substantially the same depth in the light guide.

15. The method of claim 14 wherein the pulses are uniformly spaced apart so that the notches or grooves are uniformly spaced apart to extract transmitted light from the light guide in a consistent manner.

16. The method of claim 14 wherein the spacing between the pulses is varied to vary the spacing between the notches or grooves to cause more or less of the transmitted light to be extracted from the light guide.

17. The method of claim 1 wherein the laser is de-focused during laser pulsing to provide the notches or grooves with a roughened or bubbled surface finish.

18. The method of claim 1 wherein the laser has a beam diameter that is varied during laser pulsing to vary the width of the notches or grooves along their length to cause more or less transmitted light to be extracted from the light guide.

19. The method of claim 1 wherein a power level to the laser is varied during laser pulsing to vary the width and depth of the notches or grooves.

20. The method of claim 1 wherein the light guide is an optical fiber, rod, panel, film, sheet or plate.

21. The method of claim 1 wherein the light guide is an optical fiber.

22. The method of claim 21 wherein the optical fiber is a flat optical fiber having a greater width than height.

23. The method of claim 21 wherein the optical fiber includes a light conducting core and a cladding surrounding the core.

24. The method of claim 23 wherein the notches or grooves extend through the cladding.

25. The method of claim 23 wherein the notches or grooves extend through the cladding and at least partway through the core.

26. The method of claim 23 wherein the notches or grooves extend all the way through the cladding and core.

27. An illuminator comprising at least one flat optical fiber having opposite flat sides and opposite side edges and ends, the fiber having a cladded light conducting core for conducting light entering an end of the fiber by internal reflection, and a pattern of U shaped notches or grooves in at least one side of the fiber along at least a portion of the length of the fiber to cause conducted light to be emitted from the fiber.

28. The illuminator of claim 27 wherein the notches or grooves are laser cut in one or both sides of the fiber.

29. An illuminator comprising a light guide having at least one light receiving edge for receiving light from a light source for transmission through the light guide by internal reflection, some of a surface of the light guide being coated with a masking material, and a pattern of shallow U shapes notches or grooves that are laser cut in unmasked areas of the surface for causing at least some of the transmitted light to be reflected or refracted out of the light guide.

30. An illuminator comprising a light guide having at least one light receiving edge for receiving light from a light source for transmission through the light guide by internal reflection, at least some surface of the light guide being coated with a material to enhance laser cutting of the surface, and a pattern of shallow U shaped notches or grooves cut in the surface of the light guide using a laser for causing at least some of the transmitted light to be reflected or refracted out of the light guide.

31. An illuminator comprising a light guide having at least one light receiving edge for receiving light from a light source for transmission through the light guide by internal reflection, and a pattern of U shaped shallow notches or grooves in a surface of the light guide for causing at least some of the transmitted light to be reflected or refracted out of the light guide, at least some of the light guide having an adjacent optical device in the form of cladding to help keep some of the transmitted light in the light guide.

32. The illuminator of claim 31 wherein the cladding is on one or more sides of the light guide.
